(19) United States
(12) Patent Application Publication
(10) Pub. No.: US 2013/0112764 A1
(43) Pub. Date: May 9, 2013

(54) Portable Dehumidifier Device For Guitars

(71) Applicants: Hoe Cheong Chan, Singapore (SG); Wai Mun Larry Chan, Singapore (SG)

(72) Inventors: Hoe Cheong Chan, Singapore (SG); Wai Mun Larry Chan, Singapore (SG)

(21) Appl. No.: 13/809,158

(22) PCT Filed: Jul. 8, 2011
(86) PCT No.: PCT/SG2011/000243

§ 371 Date: Jan. 8, 2013

(30) Foreign Application Priority Data
Jul. 14, 2010 (SG) 2010005093-8

(51) Int. Cl. G05D 22/02; H05B 3/20; G10G 7/00

(52) U.S. Cl. CPC G05D 22/02; G10G 7/00; H05B 3/20
USPC 236/44 C; 219/221

(57) ABSTRACT

A portable dehumidifier device that is capable of controlled dehumidification by providing heat source constantly to dehumidify, also known to be the process of drying, particularly in this invention, the dehumidification is controlled and targeted, and is designed for acoustic guitar (includes classic, folk) or the like, and these instruments are known to be susceptible to dimensional distorsions like bulging or loosening of joints when subject to high humidity conditions. The dimensional distorsions have detrimental effects on the guitars and the like over the expected life span. Such instruments consists of a soundbox constructed various type of woods and parts, being glued together as an assembly commonly known as the soundbox, also with a soundhole made unto the soundbox, and with attached steel or nylon strings over the soundbox as the primary the source for generating vibration thus leading to conversion into audible sound energy. The device, made up of three major parts, consists of a torso that hold all other parts together. Attaching to the torso is an insulated heater that provides the required heat energy to influence the relative humidity level within the soundbox. A display & control unit, connected to the torso unit by mean of plug and cables, serves to provide power from the regular home power mains to the insulated heater through the torso. On the torso, a temperature and humidity probe is positioned strategically to detect and measure changes of its surroundings and draws it power from the display & control unit too. The temperature and humidity information is fed back to the display & control unit to inform the users of the current temperature and humidity conditions. The subassembly, insulated heater comprises of a heater casing that serves to house the heating element that provide constant heat energy, and a conceal plate to hold the heating element within the heater case. Regardless of the presence of strings, through manipulating the torso and swivel hander, the insulated heater can be inserted into the soundhole while the upper part of the torso remains outside, incidentally resting on soundbox whilst the guitar is in a supine position, and the soundhole is facing up. When the device is powered up, the insulated heater provides heat energy gradually whilst positioned within the soundbox thus altering the relative humidity level within the soundbox. The device when in operation employs the three principles of drying wood, i.e. (1) constant energy as heat, (2) makes the air within the soundbox to take in moisture from its wood (3) and maintains air circulation by keeping the soundhole opened. With the application of these three principles, dehumidification is ensured.

### FIELD OF THE INVENTION

1. Background to the Invention

The invention aims to provide controlled dehumidification for acoustic guitars and the like, specifically targeted at the wood parts, which are susceptible to damages due to exposure to high humidity conditions. String instruments such as acoustic guitars include a soundbox assembled from wood parts into an enclosed resonant chamber. Such instruments when subject to the inevitable fluctuations of relative humidity levels develop bulging of the soundbox, loosening of glue joints, diminish play-ability, discount of resonating qualities, etc, None of these are desirable and it requires costly and time consuming repair works to restore the affected string instruments back to ideal state. Such detrimental conditions are particularly prevalent in regions with average humidity level of 60% or more. Through proper controlled dehumidification, guitars or the like can be restored to its desired condition, which augments both the ease in playing the instrument and the qualities of resonance.

Dehumidification is a process of drying. The presented invention aims to dry the wood parts within the soundbox. To dry wood, three basic requirements must be met. (1) Energy in the form of heat must be provided to evaporate moisture throughout the drying process, (2) The air surrounding the wood must be capable of receiving moisture from the wood surface, i.e. the relative humidity of the surrounding air must be below 100% and (3) During drying, air movement among and around the wood to be dried must be adequate to bring energy into it, to remove evaporated moisture, and to maintain the desired relative humidity.

The presented invention is designed to operate in accordance to the three mentioned wood drying requirements. The device is capable of providing constant yet gradual energy in the form of heat, the heat source caused the air within the soundbox to increase in moisture absorbing capability, and air movement is not prevented as the soundhole is not sealed.

2. Existing Practices

Devices available to alleviate those undesirable effects include portable dehumidifiers (E.g. U.S. Pat. No. 368,770, Tanner & Smith, U.S. Pat. No. D508,735 S, Klein, U.S. Pat. No. D535,371 S, Bushee) of specifications like 15 to 100 litres of absorption capacity and power rating of 200 to 1000 Watts respectively which are designed to control humidity of an enclosed space, typically a room of certain known purposes by taking moist air from its surrounding and removing its moisture and recycling the air back to the surroundings through a blower outlet found on such dehumidifiers. Although they are termed as portable dehumidifiers, it is merely a relative term applied when comparing to other mammoth sizes, commercially used dehumidifiers. They range from overall dimensions like 540×320×355 mm to 880×420×460 mm. Travelling with these portable dehumidifiers isn't a viable option. While these dehumidifiers are not specifically designed for guitars or the like, nevertheless it is common to employ such portable dehumidifiers to remove the excessive moisture in guitars and the like to its desired moisture content by mean of directing the dry air at the top of the guitar's soundbox or allowing the guitar(s) to left outside of the case(s) within a fully closed room with one of such portable dehumidifiers in operation for days. Operating these dehumidifiers for extensive period can consume a consideration amount of energy. Leaving a room reserved for such purpose is probably not a luxury possessed by many as well.

Another powered operated device used for the same purpose is the dry cabinet (patent application Ser. No. 10/750,418) however is primarily designed to maintain a certain humidity level within the enclosed space of the cabinet; therefore it is adequate for storing of certain moisture sensitive electronics devices. Available in various sizes, those dry cabinets that can house guitars or the like are used for containing guitars for a predetermined time frame thus achieving the effect of restoration of the moisture content to desired level. The cost of acquiring a dry cabinet adequate to house a guitar is not expected to be reachable to everyone. Moreover, little is known about its effectiveness.

Other forms of devices are sachets or beanbags filled with moisture adsorbing agents which are designed to be most effective when placed inside the instrument case or within the soundbox. Such moisture adsorbing agents are left within the guitar to take effect passively. Because the case is not impermeable to moisture, such agents frequently needs to be de-moistened (the act of removing moisture). Moreover, such agents lose its absorbing ability after repeated de-moistening. Regarding its effectiveness in removing moisture carried by wood, suffice to say that it is a common physics that wood is hygroscopic and absorbing moisture is a natural phenomenon but the reverse will prove to be difficult.

### SUMMARY OF THE INVENTION

The presented invention aims to make the process of dehumidification of guitars and the like simple, accessible and portable. Through its simplicity, the existing practices that have implied inconveniences and tough-to-meet demands can be eradicated thus widening and deepening the outreach for enthusiasts who enjoy caring for their instruments.

The presented invention, a.k.a. the device comprises of a torso cum an insulated heater that made a subassembly, and the display & control unit. The torso holds all parts together, bore the shape of an asymmetrical polygon that is specifically shaped to be inserted into the soundbox partially whilst the acoustic guitars or the like are in a supine position, regardless the presence of instruments' strings, and avoiding any direct contacts with the interior of the soundbox. When placed and oriented in its intended seating, only a portion of the torso is resting on the exterior surface of the soundbox. The rested portion is the only contact area between the device and the acoustic guitar or the like in treatment.

A swivel handle that is mounted on the torso, serves to facilitate the manipulation of the torso. Once the torso is seated, the resulting position of the insulated heater will be directly beneath the underside of the acoustic guitar bridge area a.k.a. the targeted area of acoustic guitars. Importantly, no part of the device will make contact with any parts of the interior of the soundbox. Targeted areas will inevitably vary with the design structure of the to-be-treated string instruments; therefore identifying these targeted areas prior to carrying out the dehumidification is critical.

The torso subassembly is designed to be self-balanced, and to rest in equilibrium for its entire operation process. Another integral part, the insulated heater comprises of a heater case made of heat resisting and insulating polyethylene, housed a suitably sized low power heating element within, complete with a conceal plate to secure the heating element within the heater case by means of mounting screws. In making the heating process gradual, heat flow is controlled to emit from the underside of the heater case. To enable this, predetermined size and numbers of thin slots are cut into the conceal plate which allow heat to dissipate downwards and rise up eventually.

Power is supplied to the heating element through embedded cables within the torso. The display & control unit provides temperature and humidity information to the users that comprises of two cables, one terminates at the regular household power source and the other terminates at the torso by connection to a group of terminal pins found at the torso. Through the connections, the device will receive its required power supply to operate.

The temperature and humidity probe is located strategically on the torso to detect the changes in conditions within the soundbox. The display & control unit is programmed with two fail-safe features i.e. (1) overheating due to heat trapping and (2) overheating due to excessive operating duration, to protect the string instruments in treatment. The temperature probe monitors the temperature within the soundbox and will cut off the power supply to the insulated heater when the temperature is excessive. The other fail-safe feature monitors the operating duration. When users operate the device beyond the predetermined duration, the power supply will be cut off to prevent any damages to the string instruments in treatment.

For acoustic guitars and the like that have absorbed excessive moisture from the atmosphere, this process de-moistens the instrument from the “wet” conditions back to its desired moisture content thus augmenting the ease in playing and qualities of resonance. With regards to ease in playing, the height at 12^{th} fret, i.e. a widely recognized property that can be measured on acoustic guitars is used as a reference or guide to determine the ease in playing (FIG. 7). When the string height at 12^{th} fret is 3 mm (0.118 inch) or more, most guitar players will find the ease in playing drastically reduced. The qualities in resonance will inevitably diminish too. While the factors that contributed to the diminishing of ease in playing and qualities of resonance are many, bulging surface due to high humidity or “wet” conditions is certainly one of the key contributors. Through proper controlled dehumidification, guitars or the like can be restored to its desired condition, for the case of guitars, the string height at 12^{th} fret can be reduced which augments both the ease in playing and it qualities of resonance.

The air within the soundbox gets warmed gradually by the insulated heater, thus increases its capacity to absorb moisture. When the air within becomes more absorbent than the wood parts of the soundbox, the moisture within wood will gradually be transferred to the air in the soundbox. Air circulation is not prevented since the soundhole is not sealed, therefore allowing the removal of the evaporated moisture by means of air circulation. Invariably, the air circulation also eliminates the possibility for the soundbox to become a heat trap which is undesirable to the well being of string instruments.

### DESCRIPTION OF THE DRAWINGS

FIG. 1 is a perspective view of one embodiment of the dehumidifier of the presented invention, it exhibits the intended application to an instrument, in this drawing an acoustic guitar is presented, also a cut-away view to expose the dehumidifier's placement and orientation whilst in operation.

FIG. 2 is the side view of the device, it exhibits the intended application to an instrument, in this drawing an acoustic guitar is presented in a supine position, also seated within its case. A cut-away view is introduced to expose the device's placement and orientation in relation to the interior of the soundbox.

FIG. 3 is a closed-in side view to showcase the various parts of the device.

FIG. 4 is a closed-in bottom view to feature the insulated heater.

FIG. 4A is the exploded view of the insulated heater unit, the presented parts will bear the same number notation as labelled in FIG. 4 as they are identical parts.

FIG. 5 is a closed-in view of the display & control unit.

FIG. 6 is the temperature profile of the normal operating conditions.

FIG. 7 is a closed up illustration of “string height at 12^{th} fret”.

### DETAILED DESCRIPTION OF THE PREFERRED EMBODIMENT

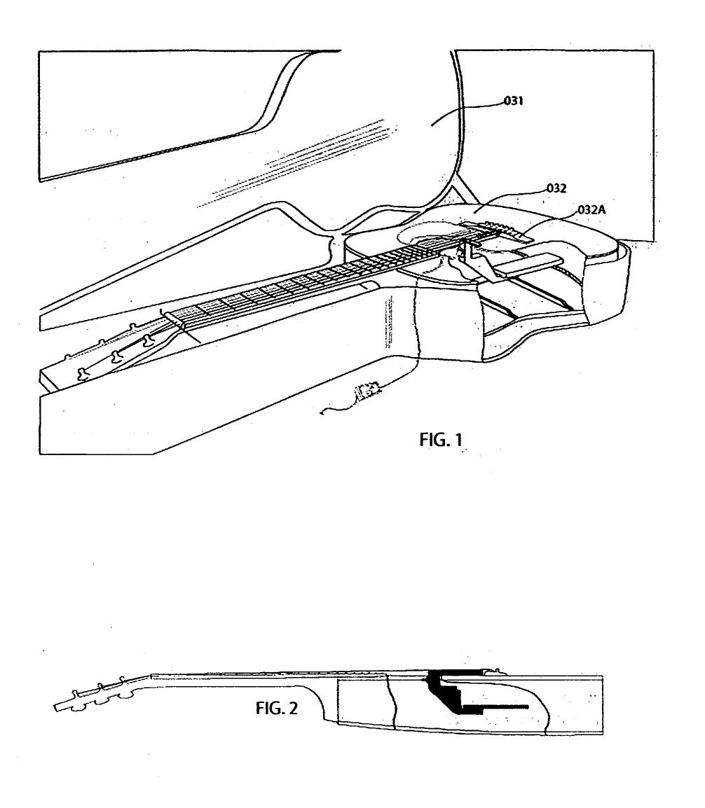

Referring to the drawings, in FIG. 1 shows a string instrument, herein presented an acoustic guitar as 032 seated within its case indicated as 031. While the presented invention herein may primarily discuss about acoustic guitars, it is equally applicable to other types of guitars, or string instruments of wood constructed parts, consisting of a soundbox and also an opening on it that permits the entry of the presented invention with ease.

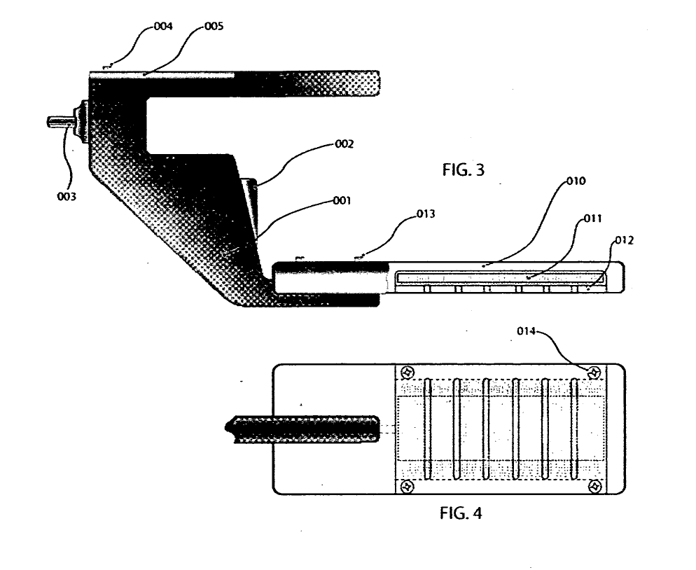

FIG. 1 presented an embodiment of the presented invention in its intended operating set-up which includes the torso and insulated heater subassembly (FIG. 3), and the display & control unit (FIG. 5). It is inserted into an acoustic guitar 032, specifically into its soundbox, while the guitar is seated in a supine position within 031, the case.

In the intended set-up as indicated in FIG. 1, the acoustic guitar is in supine position seated within the case, the subassembly which comprises of the torso and insulated heater is manipulated to reach its intended seating without the need to removed the instrument's strings. Torso 001 is placed and oriented partially within the soundbox, by inserting into the soundhole and leaving only the portion with the swivel handle 005 rested on the exterior surface of the soundbox, or specifically rested between the soundhole and the guitar bridge 032A. When placed and oriented in this manner, the resulting placement and orientation of the insulated heater will be within the soundbox and beneath the underside of the guitar bridge 32A a.k.a. the targeted area. The mentioned position of the insulated heater is critical to dehumidification effectiveness. The display & control unit 020 comprises of the cable power source 021 to be connected the regular household power sources, commonly of rating of 110AC/240AC depending on various regions, and the plug & cable 003 to be connected to the torso 001 to complete routing of the power source thus operating the device. The placement of the display & control unit should be as accommodating as the length of the cables, also not obstructing the torso 001. Avoid placing near heat sources or locations of potential damages by unplanned human activities.

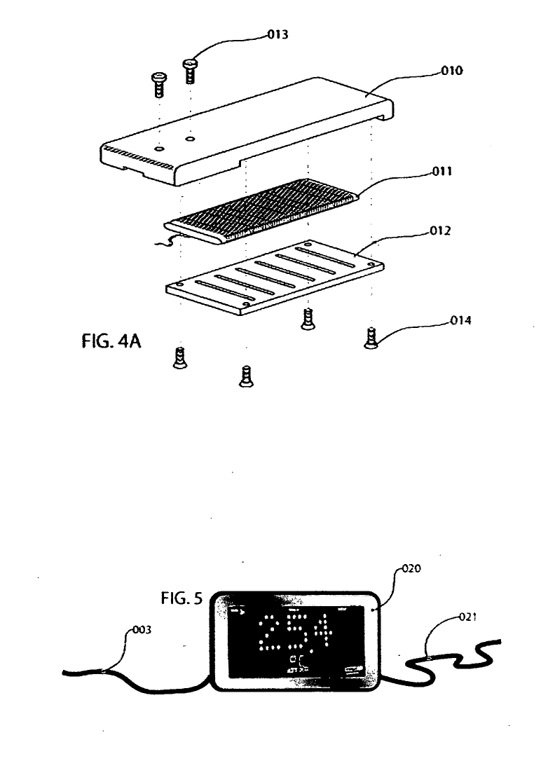

Torso 001, it holds all other parts in their intended positions, also an integral part of the subassembly. This asymmetrical polygon shaped like a modified horseshoe has two extended arms pointing in a common direction that form the stepped valleys. It is deliberately shaped to achieve a self-balanced state when the device is manipulated to its intended seating, also to avoid contacts with the wood pants within the soundbox (see FIG. 1). At the end of one extended arms, the heater case 010 is mounted to it by (FIG. 4A) mortise fit between the extended arm and heater case and screws.

The temperature cum humidity probe 002, is mounted within the torso 001. A canal is bored to allow cables to be laid to bridge the electrical signals between the probe 002 and the display & control unit 020. This connection also enables power source to activate the probe 002 and also transmit electrical signals that are eventually translated into digital readings on the display & control unit 002.

On the upper extended arm of the torso, there fitted the swivel handle 005 and the mounting screw 004. When manipulating the subassembly, users can swing the handle 005 up to 90° angle on either side. The swivel handle 005 is most effective when the subassembly is manipulated such that the upper arm of the torso 005 is under the guitar strings. With the guitar strings obstructing the user, the handle 005 is swivelled to be free from guitar strings obstruction which facilitates the user to continue in manipulating the device delicately to its intended position.

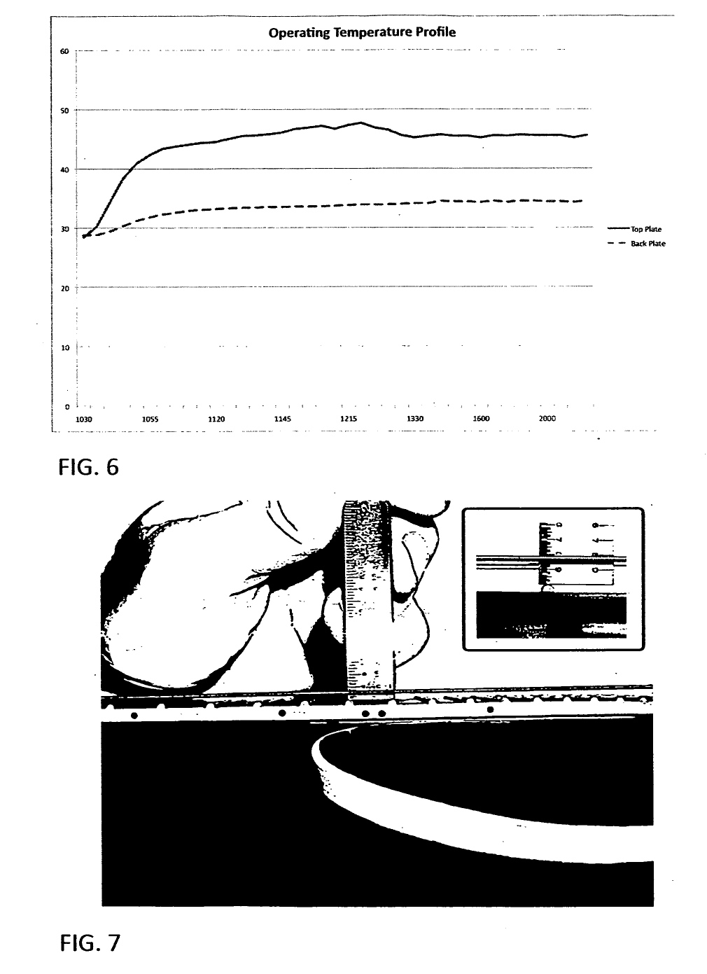

The insulated heater comprises of the heater case 010, heating element 011, conceal plate 012 and the mounting screws 014. They made up a subassembly. To dehumidify is to dry, a basic requirement is the presence of heat energy. The heater element 011 is suitably sized in its power rating thus provides the heat energy to drive the dehumidification process. The heater case 010 contains the heater element 001 within, and by the use of screws, the conceal plate 012 is fastened to the underside of the heater case (FIG. 4A) that secures these various parts into one subassembly. When the device is in its intended seating, the insulated heater is directly under the targeted area. Heater case 010 is made of heat insulating and resistance materials which prevent conduction of heat to its top surface. The primary function is to prevent direct heating of the targeted area. Instead, the conceal plate 012 that has openings in the form of slots (FIG. 4A) being cut into it that allow heat to be dissipated downwards and rises up eventually into the space within the soundbox, also in this case heating the targeted area. Consequently, the heating of the targeted area is gentle and gradual which is indicated by the operating temperature profile shown in FIG. 6. When heat is delivered to the targeted area gradually, dehumidification of guitars and the like can be achieved through the use of low power heating, which incidentally the power rating of the heating element 011 ranges between 8 to 10 watts. Invariably, the gradual heating pattern eliminates drastic heating related damages to guitar or the like. Moreover cables that deliver power to the heating element 011 are concealed within the torso 001 thus minimizing damages by handling and electrocution of users. This is the essence of controlled dehumidification that is unique to the presented invention.

To empower users a sense of control over this device, the temperature and humidity probe 002 continuously monitors the operating conditions and sends the information to the display & control unit 020. Users can read from the display & control unit 020 the actual temperature and humidity. The display & control 020 unit is programmed with two fail-safe features. i.e. (1) overheating due to heat trapping and (2) overheating due to excessive operating duration, to protect the string instruments in treatment. The temperature probe 002 monitors the temperature within the soundbox and will cut off the power supply to the insulated heater when the temperature is excessive. The other fail-safe feature monitors the operating duration. When users operate the device beyond the predetermined duration, a timer will override the operation by cutting off the power supply as a mean of shutting the device down thus preventing any damages to the string instruments in treatment.

Cable power source 021 when connecting to any regular household power source wall plugs, supplies power to the display & control unit 020 and when the plug & cable 003 is also connected to the torso 001, the heating element 011 will receive its power. Completing these connections will enable to the device to operate. Depended on the regions, the suitable transformers can be provided to address the varying power ratings. The common ones to be accommodated in this device are 110 and 240 AC power rating. Cable power source 021 shall terminate with common plugs that are best suited for the destination the device is heading to.

The device has a combined weight with all parts and containment from 220 to 280 grams. When fitted into a containment the overall dimensions are 250×110×80 mm. Within the containment, preferably it is fitted with impact dampening packing materials to allow the device to seat snugly with minimum movements. The outer shell of this containment should be of sturdy and protective to the device. By the weight and dimensions of the device, it makes travelling with or transporting it easy, which makes it truly portable to the users.

FIG. 6 shows the operating temperature profile of a typical operating condition for 12 hours. It took about 30 minutes for the targeted area to experience 16° C. of increase in temperature from 28° C. to 44° C. Air circulates freely during the heating process, the heating element generates 8 to 10 watts it pales in comparison to most household heating appliances of 40 watts or more, and heat can escape through the soundhole and seams on the guitar; as such heat induced damages to wood whilst the drying process is not possible. Moreover, the temperature began to stabilize as the air circulates that eventually arrives to the steady phase.

Controlled dehumidification is attainable by targeted treatment, sizing the insulated heater, and the deliberated features that are designed into the device. A typical portable free-standing dehumidifier of 15 litres can consume up to 270 watts per hour. By applying the concept of targeted treatment, low power ratings of 8 to 10 watts per hour can be equally effective as those portable dehumidifiers with only a fraction of their power consumption. This directly translates to the cost of maintaining guitars or the like.

1-19. (canceled)

20. A portable dehumidifier for a musical instrument having a soundbox, the heater comprising:
a torso substantially of a horseshoe shape, wherein an upper arm of said horseshoe shaped torso is operable to be placed on an exterior surface of said soundbox when said musical instrument is placed in a supine position and a lower arm of said horseshoe shaped torso, being longer than said upper arm, projects into an interior space of said soundbox, without contacting any interior surface of said soundbox; and
a heating element of substantially 8 to 10 watts is located on said lower arm.

21. A portable dehumidifier according to claim 20, wherein said musical instrument has a plurality of strings strung across the soundbox and said plurality of strings are connected to a bridge plate disposed on said exterior surface of the soundbox.

22. A portable dehumidifier according to claim 21, wherein when said upper arm of said portable dehumidifier is suspended on said exterior surface of said soundbox, said heating element is substantially located below said bridge plate.

23. A portable dehumidifier according to claim 20, wherein said heating element is concealed in said lower arm and said lower arm has open slots disposed on the underside, so that heat generated from said heating element emits downward from said open slots to give gentle heat distribution within said soundbox.

24. A portable dehumidifier according to claim 23, wherein said heating element is surrounded by a heat insulating case.

25. A portable dehumidifier according to claim 20, further comprising a controller, which regulates said heating element by predetermined temperature and/or timer settings.

26. A portable dehumidifier according to claim 21, further comprising a handle that extends to one side or both sides of said upper arm to facilitate placement of said portable dehumidifier without removing any of said plurality of strings.

27. A portable dehumidifier according to claim 25, further comprising a temperature and humidity sensor disposed on said torso at a location intermediate between said upper and lower arms, so that the temperature inside the soundbox is fed to said controller to regulate said heating element.

28. A portable dehumidifier according to claim 27, further comprising a display for indicating the temperature and humidity conditions inside said soundbox as detected by said temperature and humidity sensor.
